(19) United States
(12) Patent Application Publication
(10) Pub. No.: US 2006/0290940 A1
(43) Pub. Date: Dec. 28, 2006

(54) Ring laser gyroscope combination sensor

(76) Inventors: Richard G. Beaudet, Inver Grove Heights, MN (US); Brittan L. Zurn, Roseville, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/319,890

(22) Filed: Dec. 28, 2005

Related U.S. Application Data
(60) Provisional application No. 60/692,977, filed on Jun. 22, 2005.

(51) Int. Cl. G01C 19/66

(52) U.S. Cl. 356/470

(57) ABSTRACT

A ring laser gyroscope is described that includes a laser block having a laser cavity, a readout mirror adjacent a portion of the laser block, and a sensor. The laser block is configured to propagate both a clockwise and a counter-clockwise laser beam within the laser cavity. The readout mirror is adjacent a portion of the laser block and is configured to allow at least a portion of both the clockwise laser beam and the counter-clockwise laser beam to pass through. The readout mirror also causes at least a portion of the clockwise laser beam and at least a portion of the counter-clockwise laser beam to overlap. The sensor generates a readout signal from an overlapping portion of the laser beams and a laser intensity monitor signal from a non-overlapping portion of the laser beams.

### CROSS REFERENCE TO RELATED APPLICATIONS

This application claims the benefit of U.S. provisional application No. 60/692,977 filed Jun. 22, 2005, which is herein incorporated by reference in its entirety.

### BACKGROUND OF THE INVENTION

This invention relates generally to ring laser gyroscopes, and more specifically, to a ring laser gyroscope which utilizes a single combined sensor to obtain two ring laser gyroscope performance signals that are typically generated by ring laser gyroscopes which incorporate two separate sensors, one for each performance signal.

A ring laser gyroscope utilizes interference of laser light within a ring optical cavity to detect changes in orientation and rate of turn. At least some known ring laser gyroscopes utilize two optical sensors, which provide signals to respective electronic circuits to generate ring laser gyroscope output signals. One such optical sensor is sometimes referred to as a laser intensity monitor sensor, and the other optical sensor is sometimes referred to as a readout sensor.

The laser intensity monitor sensor and associated electronic circuitry generate at least a laser intensity monitor monitor signal, a residual path length control (PLC) modulation signal, and a residual single beam signal (SBS) which are utilized in the operation of the ring laser gyroscope. The readout sensor and its associated circuitry generate readout signals, which, in one known ring laser gyroscope, are ninety degrees out of phase from one another, representing an optical fringe pattern having a frequency and phase. The readout signals are utilized in the determination of changes in an orientation and a rate of turn, for example, of a flight platform in which the ring laser gyroscope is installed. More specifically, as the fringe pattern moves across the readout sensor, the readout sensor and associated circuitry produce a series of pulses, the number of pulses created represents an angle or orientation of the flight platform, and a rate at which the pulses are created is representative of a speed of rotation (e.g., a rotation rate) of the flight platform in which the ring laser gyroscope is mounted.

Drawbacks to the known two sensor ring laser gyroscopes include production cycle time, cost, sensor inventory due to a need to match a normal distribution of gyroscope fringe patterns to a corresponding grid pattern on the readout sensor, low readout signal (power), and gyroscope life due to the original signal strength degrading over time.

### BRIEF SUMMARY OF THE INVENTION

In one aspect, a ring laser gyroscope is provided that comprises a laser block comprising a laser cavity, a readout mirror adjacent a portion of the laser block, and a sensor. The laser block is configured to propagate both a clockwise and a counter-clockwise laser beam within the laser cavity. The readout mirror is configured to pass at least a portion of both the clockwise laser beam and the counter-clockwise laser beam, and further configured to cause at least a portion of the clockwise laser beam and at least a portion of the counter-clockwise laser beam to overlap. The sensor is configured to generate a readout signal from an overlapping portion of the laser beams and a laser intensity monitor signal from a non-overlapping portion of the laser beams.

In another aspect, a sensor for a ring laser gyroscope is provided. The sensor is configured to receive counter propagating laser beams, generate a readout signal from an overlapping portion of the counter propagating laser beams, and generate a laser intensity monitor signal from a non-overlapping portion of the counter propagating laser beams.

In still another aspect, a method for processing counter propagating laser beams in a ring laser gyroscope is provided. The method comprises passing the counter propagating laser beams through a partially transmissive mirror to create areas of at least partial beam overlap and areas of non overlap, generating a readout signal from an area of beam over lap, and generating a laser intensity monitor signal from an area of non overlapping beams.

### BRIEF DESCRIPTION OF THE DRAWINGS

FIG. 1 is a diagram illustrating optical components and an optical path for transmitted beams within a ring laser gyroscope.

FIG. 2 is a diagram depicting laser beams propagating to and from optical components within a ring laser gyroscope.

FIG. 3 is an illustration of a cross-section of non-overlapping laser beams utilized with a laser intensity monitor sensor.

FIG. 4 is an illustration of a cross-section of overlapping laser beams utilized with a readout sensor.

FIG. 5 is a diagram depicting laser beams propagating to and from optical components within a ring laser gyroscope that integrates the functions of a readout sensor and a laser intensity monitor sensor into a combined sensor.

FIG. 6 is a diagram illustrating portions of laser beams that fully overlap, partially overlap and do not overlap as they pass through a readout mirror.

FIG. 7 is an illustration of a cross-section of partially overlapping laser beams utilized with a combined sensor for a ring laser gyroscope.

FIG. 8 illustrates a gridline pattern and apertures for utilization in a combined sensor for a ring laser gyroscope.

FIG. 9 is a schematic diagram illustrating an electrical configuration for the combined sensor.

### DETAILED DESCRIPTION OF THE INVENTION

A ring laser gyroscope is described herein which includes a sensor that combines the functions of a readout sensor and a laser intensity monitor sensor. The combined sensor utilizes partially overlapping beams emanating from a laser block to generate the optical inputs needed to generate both laser intensity monitor and readout signals. An overlapping portion of the laser beams is utilized generate the readout signal and a non-overlapping portion of the laser beams is utilized to generate the laser intensity monitor signal.

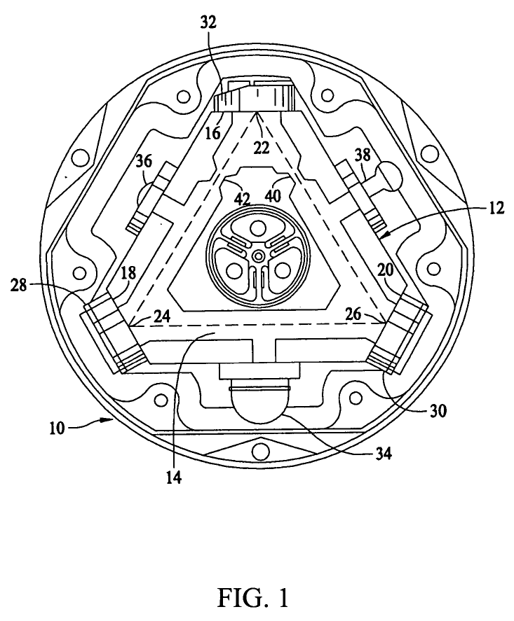

FIG. 1 is a diagram illustrating optical components and an optical path for transmitted beams within a known ring laser gyroscope 10. Ring laser gyroscope 10 includes a substantially triangular laser block 12 that provides a ring laser cavity 14 containing lasing gas. Laser block 12 includes block surfaces 16, 18, and 20 between which is an optical laser path with vertices 22, 24, and 26 at respective block surfaces 16, 18, and 20. Mirror assemblies 28, 30, and 32 are mounted to block surfaces 16, 18, and 20, respectively. Ring laser cavity 14 is filled with a lasing gas that is ignited or excited by a sufficient voltage between cathode 34 and each of anodes 36 and 38. In turn, a pair of counter-propagating laser beams travel along the optical laser path within laser cavity 14. One or more of mirror assemblies 28, 30, and 32 are transmissive, which allows a portion of the counter-propagating laser beams to pass through the mirror and onto sensors as further described below.

In use, the two laser beams are generated and propagated in opposite directions around the closed loop path of laser cavity 14 about the axis of rotation of ring laser gyroscope 10. Rotation of ring laser gyroscope 10 causes the effective path length for the two beams to change, thus producing a frequency difference between the two beams since the frequency of oscillation of the laser beams is dependent upon the length of the optical laser path. The frequency difference between the beams causes a phase shift between the beams that changes at a rate proportional to the frequency difference. The interaction of the beams produces an interference fringe pattern which is observed to move with a velocity proportional to the rate of angular rotation of ring laser gyroscope 10 about the axis of rotation.

In the closed loop path of laser cavity 14, gas discharge currents flow in opposite directions, from anode 36 to cathode 34 and from anode 38 to cathode 34. These gas discharge currents generate the oppositely traveling laser beams that travel within laser block 12, passing through apertures 40 and 42. Apertures 40 and 42 are centered in the laser propagation path of laser cavity 14, and are sufficiently narrow to reduce the effects from other modes of laser propagation, while not substantially affecting results of the TEM₀₀ mode of laser propagation.

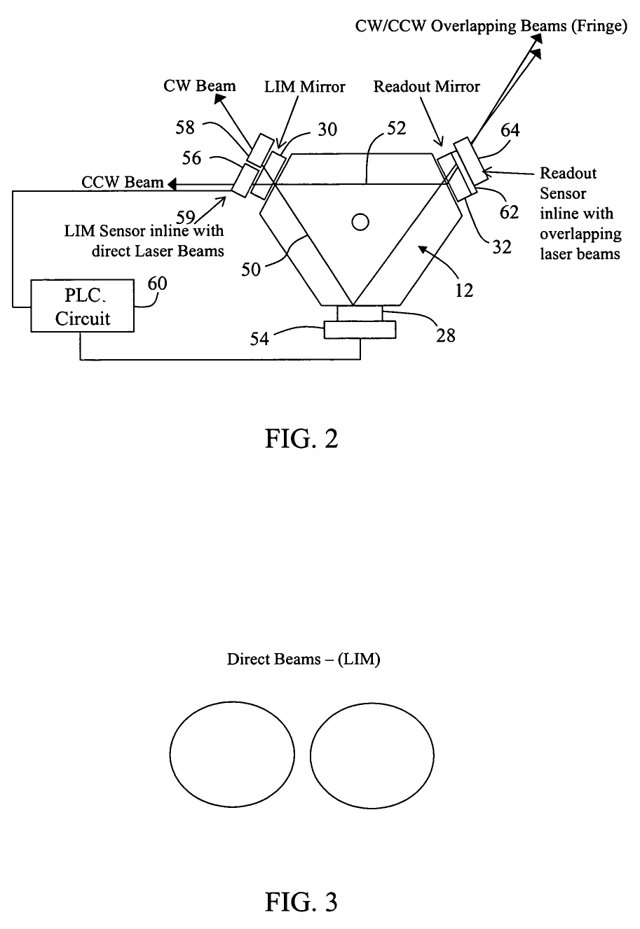

FIG. 2 is a schematic diagram depicting laser beams 50 and 52 propagating within ring laser gyroscope 10 (shown in FIG. 1). As described above, laser beams 50 and 52 are established to counter propagate in the gyroscope 10 around a close loop path by reflection from mirrors 28, 30, and 32. Mirror 28 along with a path length control driver 54 act together to change a length of laser cavity 14 (shown in FIG. 1) of ring laser gyroscope 10. Mirror 30 is a curved, partly reflective (e.g., partially transmissive), mirror which has a pair of detectors 56 and 58 mounted thereon to receive a portion of the counter propagating beams 50 and 52 to determine their intensity. The signals detected by detectors 56 and 58 are added to remove a single beam signal which acts as a noise source to a path length control circuit 60. Detectors 56 and 58 are sometimes referred to collectively as a laser intensity monitor sensor 59 which is used in conjunction with path length control circuit 60. Path length control circuit 60 is electrically connected between laser intensity monitor sensor 59 and path length control driver 54 to control the path length in the laser.

Mirror 32 is also partially transmissive and attached to a prism 62 so that the portion of counter propagating beams 50 and 52 that pass through mirror 32 are also reflected within prism 62 and subsequently directed to a readout sensor 64. A readout sensor window (not shown) is located on readout sensor 64 and is positioned adjacent prism 62. Likewise, a laser intensity monitor sensor window (not shown) is located on detectors 56 and 58 and is positioned adjacent curved mirror 30.

Ring laser gyroscope 10 and similar ring laser gyroscopes have been intentionally constrained to operate in the fundamental TEM₀₀ mode. The constraint is imposed either by use of a mask having a single aperture, for each of counter propagating beams 50 and 52, therethrough placed on the surface of laser intensity monitor sensor 59, for example, formed on a sensor window utilizing a masking process, or through the use of intercavity apertures (e.g., apertures 40 and 42 shown in FIG. 1). As a result, only a single spot of each laser beam is able to reach the respective detector. When laser intensity monitor sensor 59 indicates that a maximum intensity is reached, the path length of counter-propagating beams 50 and 52 is known to be proper for operation in the TEM₀₀ mode.

The above described ring laser gyroscope configuration uses two separate sensors (laser intensity monitor sensor 59 and readout sensor 64) to capture and generate the ring laser gyroscope output signals. As also described, the ring laser gyroscope has two separate output mirrors (laser intensity monitor mirror 30 and readout mirror 32) for this purpose. laser intensity monitor mirror 30 passes the clockwise (CW) 50 and counterclockwise (CCW) 52 laser beams directly out of the mirror. The two laser beams 50 and 52 are then captured by a two element laser intensity monitor sensor 59. laser intensity monitor sensor 59 electronically adds the two signals and passes out a two component electrical signal. One component is the DC value of the laser intensity and the other is a small AC signal used for ring laser gyroscope mode selection. FIG. 3 is a representation of the beams that are passed out of laser intensity monitor mirror 30).

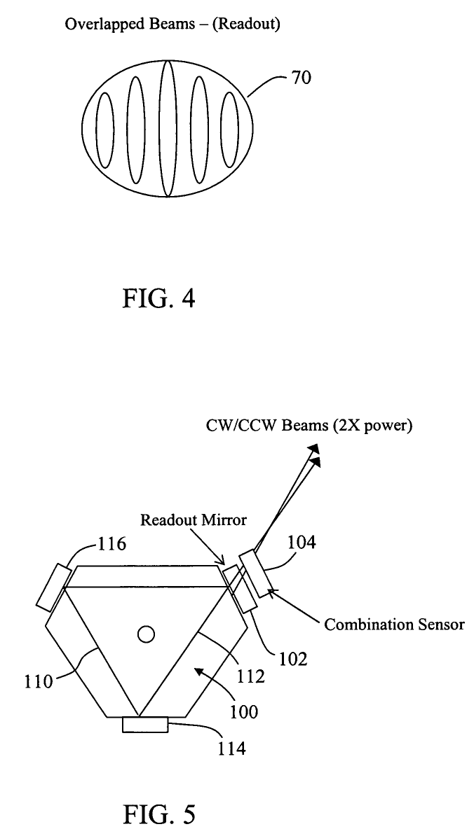

Readout mirror 32 passes both the CW and CCW laser beams 50 and 52, but after they are internally overlapped. This overlapping produces a fringe pattern 70 (alternating bright and dark regions) which is illustrated in FIG. 4. Fringe pattern 70 will move at a speed that is proportional to the ring laser gyroscope spin rate and is utilized to produce rate output information.

FIG. 5 is a schematic block diagram illustrating a triangular laser block 100 for a ring laser gyroscope, which integrates the above described functions of readout sensor 64 and laser intensity monitor sensor 59 and their associated mirrors 30 and 32 (all shown in FIG. 2), utilizing a single output mirror 102 and a combined sensor 104. In one embodiment, the total optical laser power passed through output mirror 102 is approximately the sum of the power passed through mirrors 30 and 32 utilized in the configuration of gyroscope 10 (shown in FIG. 1). The overall function and cavity losses of a gyroscope incorporating laser block 100, output mirror 102, and utilizing combined sensor 104 are approximately the same as those associated with ring laser gyroscope 10. FIG. 5 further depicts laser beams 110 and 112 counter-propagating within laser block 100 of the ring laser gyroscope. Similar to laser beams 50 and 52 described above, laser beams 110 and 112 are established to counter propagate within the ring laser gyroscope around a closed loop path by reflecting from mirrors 114 and 116 and partially reflecting from single output mirror 102.

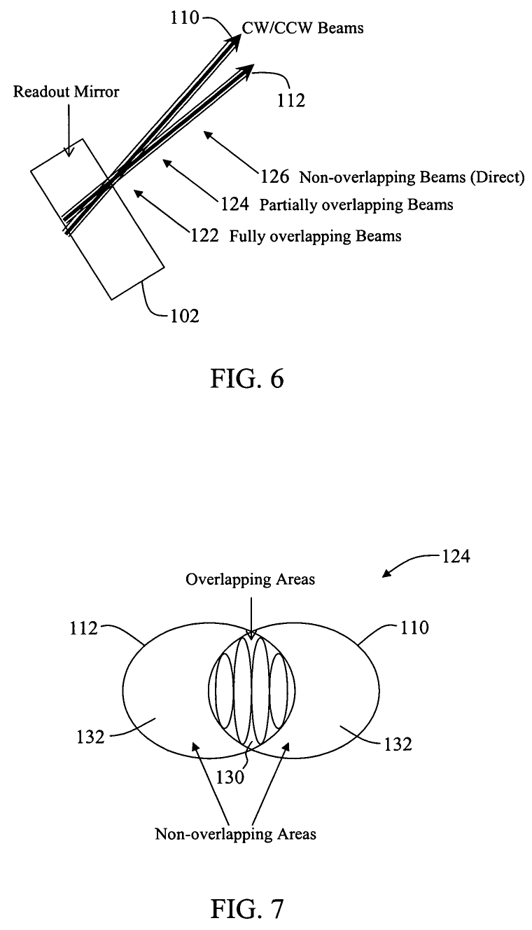

By partially overlapping laser beams 110 and 112 distinct areas of direct beam intensity and overlapped beam intensity are created, as illustrated in FIG. 6. As laser beams 110 and 112 pass through mirror 102, areas of full overlap 122, partial overlap 124, and non-overlap 126 between the two laser beams 110 and 112 is created. Because the laser power of the two laser beams 110 and 112 exiting mirror 102 is approximately twice that exiting the individual mirrors of the two sensor (and mirror) system (e.g., ring laser gyroscope 10 (shown in FIG. 1)) the total laser power should be the same. Therefore, due to the combination of laser beams 110 and 112 having twice the power (as compared to beams 50 and 52), laser beams 110 and 112 can be split into two separate areas and the total laser power will be the same as generated in the existing ring laser gyroscope 10. FIG. 7 is an illustration of partially over-lapping area 124 of beams 110 and 112 illustrating an overlapping area 130 and non-overlapping areas 132.

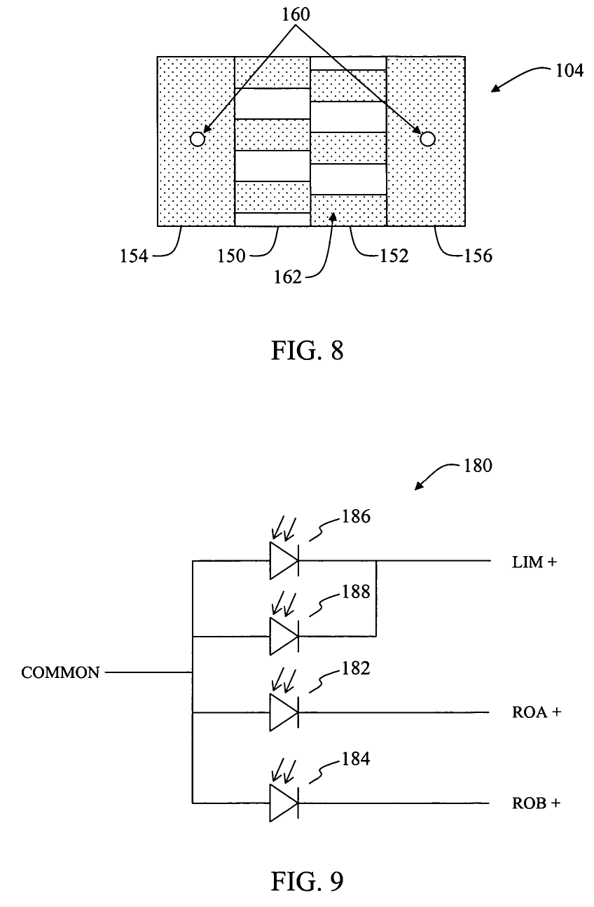

FIG. 8 is an illustration of one possible embodiment for combined sensor 104. The embodiment includes a four element rectangular sensor with all the elements arranged in a row. More specifically, two inner elements 150 and 152 have a grid line pattern which is utilized in the generation of a readout signal (e.g., fringes) and two outer elements 154 and 156 are utilized in the generation of a laser intensity monitor signal and include laser intensity monitor apertures 160. Spacing of laser intensity monitor apertures 160 is a function of the spacing of gridlines 162. A larger spacing for gridlines 162 would result in laser intensity monitor apertures 160 being spaced proportionally farther apart.

FIG. 9 is a schematic diagram 180 illustrating an electrical configuration for combined sensor 104. The schematic serves to illustrates that with a ring laser gyroscope incorporating combined sensor 104, all the electronics utilized in ring laser gyroscope 10 would continue to be utilized as is since combined sensor produces the same output signals as the separate laser intensity monitor sensor 59 and readout sensor 64 of ring laser gyroscope 10. More specifically, readout detectors for combined sensor 104 are represented by dual photo sensors 182 and 184, each of which may be masked by gridlines 162 offset by a half period. laser intensity monitor detectors for combined sensor 104 are represented by photo sensors 186 and 188, each of which may be aligned which a respective one of apertures 160 (shown in FIG. 8), to generate gyroscope control signals.

The above described embodiments describe a ring laser gyroscope that combines the functions of a readout sensor and a laser intensity monitor sensor into one combined sensor. The combined sensor utilizes partially overlapping beams emanating from a laser block to generate the optical inputs needed to generate both the laser intensity monitor and readout signals. Specifically, the overlapping portion of the laser beams emanating from a laser block is utilized generate the readout signal and the non-overlapping portion of the laser beams is utilized to generate the laser intensity monitor signal. An aperture is utilized along with the generated laser intensity monitor signal to attain correct mode discrimination. Also, a spacing between the laser intensity monitor apertures will vary based upon a readout mask spacing utilized for a particular ring laser gyroscope. At least one benefit, is that the combined sensor will reduce the number of sensors needed on ring laser gyroscope production lines by approximately one-half.

Distinct areas of direct beam intensity and overlapped beam intensity are created, and as the laser beams pass through a mirror, towards the combined sensor, areas of full overlap, partial overlap, and non-overlap between the two laser beams are created. The power of the two laser beams exiting the mirror may be approximately twice that exiting the mirrors of known laser gyroscopes so that the total laser power in the combined sensor ring laser gyroscope is about the same as that in known ring laser gyroscopes.

While the invention has been described in terms of various specific embodiments, those skilled in the art will recognize that the invention can be practiced with modification within the spirit and scope of the claims.

What is claimed is:

1. A ring laser gyroscope comprising:
a laser block comprising a laser cavity, said laser block configured to propagate both a clockwise and a counter-clockwise laser beam within said laser cavity;
a readout mirror adjacent a portion of said laser block and configured to pass at least a portion of both the clockwise laser beam and the counter-clockwise laser beam, said readout mirror configured to cause at least a portion of the clockwise laser beam and at least a portion of the counter-clockwise laser beam to overlap; and
a sensor configured to generate a readout signal from an overlapping portion of the laser beams and a laser intensity monitor signal from a non-overlapping portion of the laser beams.

2. A ring laser gyroscope according to claim 1 wherein said sensor comprises at least one aperture, the laser intensity monitor signal configured to pass through said at least one aperture to provide mode discrimination.

3. A ring laser gyroscope according to claim 1 wherein said readout mirror is configured to provide an area of fully overlapping laser beams, and area of partially overlapping laser beams and an area of non-overlapping laser beams.

4. A ring laser gyroscope according to claim 1 wherein said sensor comprises a four element rectangular sensor, said elements arranged in a row.

5. A ring laser gyroscope according to claim 4 wherein said four element rectangular sensor comprises a pair of inner elements and a pair of outer elements, said inner elements comprising a grid line pattern for generation of the readout signal, said outer elements comprising laser intensity monitor apertures for generation of the laser intensity monitor signal.

6. A ring laser gyroscope according to claim 5 wherein a spacing between said laser intensity monitor apertures is a function of a spacing of said gridline pattern.

7. A ring laser gyroscope according to claim 1 wherein said sensor comprises a pair of photo sensors configured to generate the readout signal, each said photo sensor comprising a gridline mask, said gridline masks offset from one another by one-half period.

8. A ring laser gyroscope according to claim 1 wherein said sensor comprises a pair of photo sensors configured to generate the laser intensity monitor signal, each said photo sensor aligned with a respective aperture.

9. A sensor for a ring laser gyroscope, said sensor configured to receive counter propagating laser beams, said sensor configured to generate a readout signal from an overlapping portion of the counter propagating laser beams and a laser intensity monitor signal from a non-overlapping portion of the counter propagating laser beams.

10. A sensor according to claim 9 configured to generate a laser intensity monitor signal, said sensor comprising at least one aperture, the laser intensity monitor signal configured to pass through said at least one aperture to provide mode discrimination.

11. A sensor according to claim 9 wherein said sensor comprises a four element rectangular sensor, said elements arranged in a row.

12. A sensor according to claim 11 wherein said four element rectangular sensor comprises a pair of inner elements and a pair of outer elements, said inner elements comprising a grid line pattern for generation of the readout signal, said outer elements comprising laser intensity monitor apertures for generation of the laser intensity monitor signal.

13. A sensor according to claim 12 wherein a spacing between said laser intensity monitor apertures is a function of a spacing of said gridline pattern.

14. A sensor according to claim 9 comprising a pair of photo sensors configured to generate the readout signal, each said photo sensor comprising a gridline mask, said gridline masks offset from one another by one-half period.

15. A sensor according to claim 9 comprising a pair of photo sensors configured to generate the laser intensity monitor signal, each said photo sensor aligned with a respective aperture.

16. A method for processing counter propagating laser beams in a ring laser gyroscope, said method comprising:
passing the counter propagating laser beams through a partially transmissive mirror to create areas of at least partial beam overlap and areas of non overlap;
generating a readout signal from an area of beam over lap; and
generating a laser intensity monitor signal from an area of non overlapping beams.

17. A method according to claim 16 wherein generating a readout signal comprises passing the area of beam overlap through a grid line pattern.

18. A method according to claim 17 wherein passing the area of beam overlap through a grid line pattern comprises passing the area of beam overlap to a pair of photo sensors having gridline masks offset from one another by one-half period.

19. A method according to claim 16 wherein generating a laser intensity monitor signal further comprises passing the area of non overlapping beams through at least one aperture.

20. A method according to claim 16 wherein:
generating a readout signal comprises passing the area of beam overlap through a grid line pattern; and
generating a laser intensity monitor signal further comprises passing the area of non overlapping beams through apertures having a space therebetween, the spacing between the apertures a function of a spacing of the gridline pattern.
